(19) United States
(12) Patent Application Publication
(10) Pub. No.: US 2005/0080887 A1
(43) Pub. Date: Apr. 14, 2005

(54) Redundant management control arbitration system

(76) Inventors: Chun-Liang Lee, Taipei (TW); Chi-Wai Wan, Taipei (TW); Ji-Chi Yang, Taipei (TW); Meng-Mu Yang, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/681,996

(22) Filed: Oct. 8, 2003

(51) Int. Cl. G06F 15/173

(52) U.S. Cl. 709/223

(57) ABSTRACT

A redundant management control arbitration system is proposed, which is designed for use with an information platform's management controller, such as a blade server's management controller, for the purpose of allowing the blade server to install with at least two management controllers, and which allows the firstly-installed management controller to be automatically set to active mode and the secondly-installed management controller to be automatically set to standby mode without human intervention, and further allows the standby management controller to be promptly switched to active mode in the event of a failure to the active management controller for the purpose of allowing the blade server to continue to operate normally in this event. This feature allows network system management to be more convenient and efficient than prior art

### BACKGROUND OF THE INVENTION

1. Field of the Invention

This invention relates to network server technology, and more particularly, to a redundant management control arbitration system which is designed for use with an information platform's management controller, such as a blade server's management controller, for the purpose of allowing the blade server to install with at least two management controllers, including an active management controller and a standby management controller, and which allows the firstly-installed management controller to be automatically set to active mode and the secondly-installed management controller to be automatically set to standby mode without human intervention, and further allows the standby management controller to be promptly switched to active mode in the event of a failure to the active management controller for the purpose of allowing the blade server to continue to operate normally in this event.

2. Description of Related Art

Blade server is a clustering type of network server, which is characterized by the use of a circuit board enclosure to house a cluster of server modules (commonly called “blades”), with all of these server modules providing the same server functionality. In other words, a blade server can respond to a client's request by linking any one of the clustered server modules to the client. In practice, each server module is implemented as a single circuit board (i.e., blade), which can be easily fitted to the blade server's enclosure to increase the blade server's client serving capacity.

A blade server is typically installed with a shared management controller for management control of all the server modules and shared resources such as fan-based heat dissipation modules, power supply modules, and so on. If the shared management controller fails, all of the server modules in the blade server would become inoperable that would result in a server system shutdown. Therefore, in order to prevent the blade server from shutdown due to a failure to the shared management controller, it is a common practice to install another management controller as a redundant standby unit to the blade server, so that in the event of a failure to the active management controller, the standby management controller can promptly take over all the management control tasks, including EMS (Emergency Management System) connections and all data communication channels, that were previously handled by the failed management controller, so as to allow the blade server to continue to operate normally in this event.

One drawback to the conventional use of redundant management controllers in the blade server, however, is that it requires human intervention from the network management personnel to manually set the two installed management controllers respectively to active mode and standby mode, and in the event of a failure to the active management controller, it also requires human intervention from the network management personnel to manually reconnect EMS connections from the failed management controller to the standby management controller. This practice is undoubtedly quite laborious and time-consuming, thus resulting in inefficient network system management.

### SUMMARY OF THE INVENTION

It is therefore an objective of this invention to provide a redundant management control arbitration system which allows the installed management controllers on the blade server to be automatically set to active mode and standby mode respectively without requiring human intervention from the network management personnel so as to allow network system management more to be more convenient and efficient.

The redundant management control arbitration system according to the invention is designed for use with an information platform's management controller, such as a blade server's management controller, for the purpose of allowing the blade server to be capable of using two management controllers, with one being set at active mode and the other being set at standby mode for redundancy backup.

The redundant management control arbitration system according to the invention is characterized by that it allows the installed management controllers on the blade server to be set to active mode or standby mode based which one of them is firstly installed to the blade server; i.e., the firstly installed one will be automatically set to active mode, whereas the secondly installed one will be automatically set to standby mode. In the event of a failure to the active management controller during operation, the standby management controller will be promptly switched to active mode to take over all the failed management controller's currently-handled management control tasks, including EMS (Emergency Management System) connections, so as to allow the blade server to continue to operate normally in this event. This feature allows the setting of active mode and standby mode to be carried out without human intervention from the network management personnel and without having to manually reconnect EMS connections when the active mode has been switched from the firstly-installed management controller to the secondly-installed management controller. These benefits allow the network system management to be more convenient and efficient than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing a blade server which is installed with two management control modules that are internally incorporated with the redundant management control arbitration system of the invention; and

FIG. 2 is a schematic diagram showing the internal architecture of each of the management control modules shown in FIG. 1.

### DETAILED DESCRIPTION OF PREFERRED EMBODIMENTS

The redundant management control arbitration system according to the invention is disclosed in full details by way of preferred embodiments in the following with reference to the accompanying drawings.

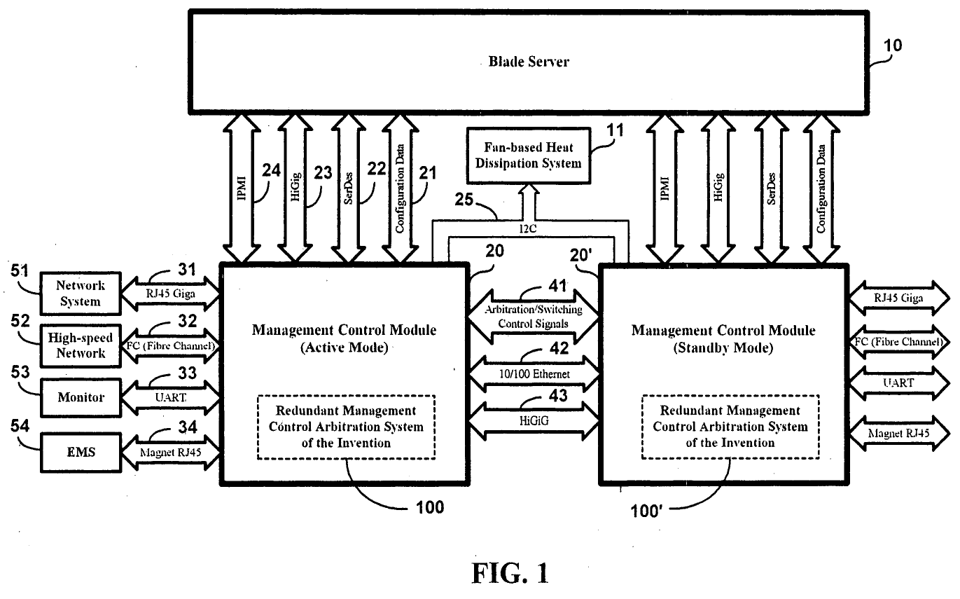

FIG. 1 is a schematic diagram showing a blade server 10 which is installed with two management control modules 20, 20′ that are each internally incorporated with the redundant management control arbitration system of the invention (respectively designed by the reference numerals 100 and 100′). These two management control modules 20, 20′ are structurally and functionally identical, and either one of which is capable of independently performing a predefined set of management control functions for the blade server 10, and includes various types of interfaces, including, for example, a group of server-oriented interfaces such as a configuration data reception interface 21, a SerDeS (Serializer and Deserializer) interface 22, a HiGiG interface 23, an IPMI (Intelligent Platform Management Interface) interface 24, an I2C (Inter Integrated Circuit) interface 25; a group of peripheral-oriented interfaces, such as an RJ45 Giga interface 31, an FC (Fibre Channel) interface 32, a UART (Universal Asynchronous Receiver/Transmitter) interface 33, and a Magnetic RJ45 interface 34. In the group of server-oriented interfaces, the configuration data reception interface 21 is used to receive a set of blade server system configuration data from the blade server 10; the SerDeS interface 22 is used for connection to each of the server modules (not shown) in the blade server 10; the HiGiG interface 23 is used for connection to a subset of the server modules of the blade server 10 that are set to high-performance mode; the IPMI interface 24 is used for connection to each of the server modules of the blade server 10 for performing IPMI-compliant management control functions; and the I2C interface 25 is used for connection to a fan-based heat dissipating system 11 to control its operations. In the group of peripheral-oriented interfaces, the RJ45 Giga interface 31 is used for connection to a network system 51, such as Internet; the FC (Fibre Channel) interface 32 is used for connection to a high-speed network system 52; the UART interface 33 is used for connection to a remote monitor 53; and the Magnetic RJ45 interface 34 is used for connection to an EMS (Emergency Management System) unit 54, which has the same IP (Internet Protocol) address for both of the management control modules 20, 20′. Since IPMI, HiGiG, SerDes, I2C, FC (Fibre Channel), UART, RJ45 Giga, and Magnetic RJ45 are all well-known and widely used standard data communication protocols in the information industry, detailed description thereof will not be given here in this specification.

In addition, each of the management control modules 20, 20′ includes a group of redundancy-oriented interfaces, including an arbitration/switching control signal bus 41, a 10/100 Ethernet bus 42, and a HiGiG bus 43, which are used for interconnections between the two management control modules 20, 20′.

In practical use, which one of the management control modules 20, 20′ is set to active mode is dependent on which one of them is firstly installed to the blade server 10; i.e., the firstly installed one will be automatically set to active mode, whereas the secondly installed one will be automatically set to standby mode. In the embodiment of FIG. 1, for example, assume the management control module 20 is firstly installed to the blade server 10 and the management control module 20′ is secondly installed to the blade server 10, then the firstly-installed management control module 20 will be automatically set to active mode whereas the secondly-installed management control module 20′ will be automatically set to standby mode. In the event of a failure to the active management control module 20, the standby management control module 20′ will be promptly switched to active mode to take over all the current management control operations that are handled by the failed management control module 20, so as to allow the blade server 10 to continue to operate normally in this event. Moreover, the two management control modules 20, 20′ are both assigned to the same IP address, so that the remotely-linked EMS unit 54 will be unaffected by the switching of the active mode from the firstly-installed management control module 20 to the secondly-installed management control module 20.

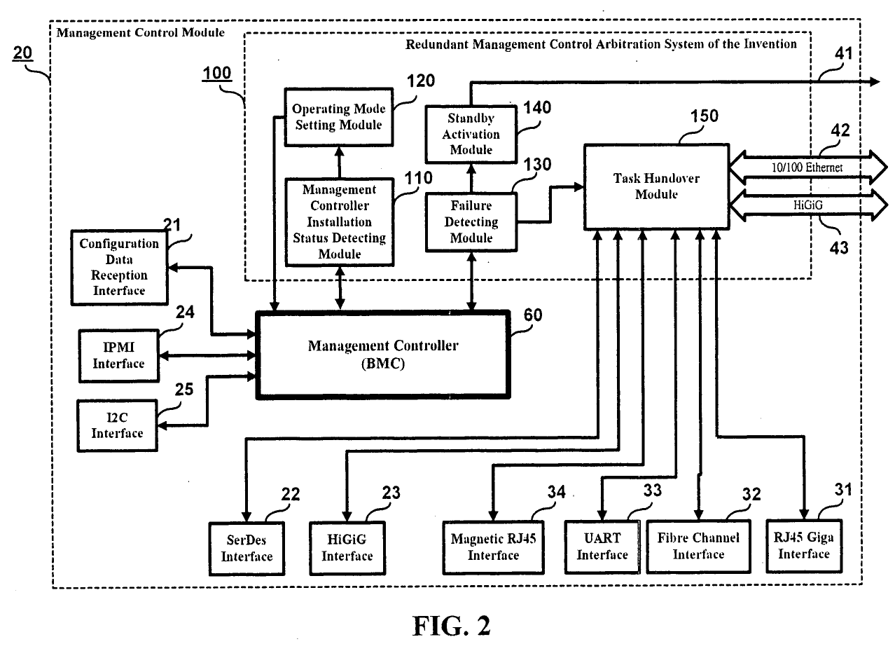

FIG. 2 is a schematic diagram showing the internal architecture of the management control module 20 (note that the other management control module 20′ is structurally and functionally identical with the management control module 20). As shown, the management control module 20 includes a management controller unit, such as a BMC (Baseboard Management Controller) unit, which is coupled to the redundant management control arbitration system of the invention 100; and the redundant management control arbitration system of the invention 100 is capable of automatically setting the operating mode of the BMC unit 60 to either the active mode or the standby mode based on whether the associated management control module 20 is firstly or secondly installed to the blade server 10. If the BMC unit 60 is set to active mode and in the event of a failure to the BMC unit 60, the redundant management control arbitration system of the invention 100 will promptly notify the standby management control module 20′ so as to set the standby management control module 20′ to active mode and switch all its currently-linked data communication channels and EMS connections to the standby management control module 20′ for the standby management control module 20′ to take over all the management control task from the failed management control module 20.

The redundant management control arbitration system of the invention 100 comprises: (a) a management controller installation status detecting module 110; (b) an operating mode setting module 120; (c) a failure detecting module 130; (d) a standby activation module 140; and (e) a task handover module 150.

The management controller installation status detecting module 110 is capable of being promptly activated when the associated management controller 20 is installed to the blade server 10 to detect whether the blade server 10 has been already installed with another management controller. This task can be done by inspecting whether a management control status signal has been set by another management controller; if NO, the management controller installation status detecting module 110 will issue an active-mode enable signal to the operating mode setting module 120; whereas if YES, the management controller installation status detecting module 110 will issue a standby-mode enable signal to the operating mode setting module 120.

The operating mode setting module 120 is capable of being activated in response to the active-mode enable signal from the management controller installation status detecting module 110 to set the associated BMC unit 60 to active mode, and capable of being activated in response to the standby-mode enable signal from the management controller installation status detecting module 110 to set the associated BMC unit 60 to standby mode. In the embodiment of FIG. 1, for example, assume the management control module 20 is firstly installed to the blade server 10 so that it is set to active mode, while the other management control module 20′ is secondly installed to the blade server 10 so that it is set to standby mode.

The failure detecting module 130 is capable of being activated in response to the event of the associated BMC unit 60 being set to active mode to continually detect whether the BMC unit 60 operates normally; if NOT, the failure detecting module 130 promptly issues a standby enable signal to both the standby activation module 140 and the task handover module 150.

The standby activation module 140 is capable of being enabled in response to the standby enable signal from the failure detecting module 130 to issue a standby activation signal via the arbitration/switching control signal bus 41 to the standby management control module 20′, for the purpose of activating the standby management control module 20′ to be switched to active mode.

The task handover module 150 is capable of being enabled in response to the standby enable signal from the failure detecting module 130 to hand over all of the failed BMC unit's currently-performed management control tasks to the standby management control module 20′. This handover task is achieved by switching all the failed BMC unit's currently-linked data communication channels and EMS connections via the 10/100 Ethernet bus 42 and the HiGiG bus 43 to the standby management control module 20′, so as to allow the standby management control module 20′ to take over all the management control tasks previously handled by the failed BMC unit 60.

In actual implementation, the above-mentioned management controller installation status detecting module 110, the operating mode setting module 120, the failure detecting module 130, and the standby activation module 140 can be implemented as a single CPLD/ASIC (Complex Programmable Logic Device & Application Specific Integrated Circuit) chipset, or implemented as a single microprocessor/firmware device module. Since CPLD/ASIC is significantly faster in speed than microprocessor-based implementation, the CPLD/ASIC scheme is more preferable.

In conclusion, the invention provides a redundant management control arbitration system, which is designed for use with an information platform's management controller, such as a blade server's management controller, for the purpose of allowing the blade server to install with at least two management controllers, and which allows the firstly-installed management controller to be automatically set to active mode and the secondly-installed management controller to be automatically set to standby mode without human intervention, and further allows the standby management controller to be promptly switched to active mode in the event of a failure to the active management controller for the purpose of allowing the blade server to continue to operate normally in this event. This feature allows the management control modules to be automatically set to active mode and standby mode without human intervention from the network management personnel and without having to manually reconnect EMS connections when the active mode has been switched from the firstly-installed management controller to the secondly-installed management controller. These benefits allow the network system management to be more convenient and efficient than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A redundant management control arbitration system for use with an information platform's management controller to allow the information platform to install with at least two management controllers, including an active management controller and a standby management controller as redundancy backup to the active management controller, and which allows the firstly-installed management controller to be automatically set to active mode and the secondly-installed management controller to be automatically set to standby mode, and further allows the standby management controller to be promptly switched to active mode in the event of a failure to the active management controller for the purpose of allowing the information platform to continue to operate normally in this event;
the redundant management control arbitration system comprising:
a management controller installation status detecting module, which is capable of detecting whether the information platform has been installed with another management controller after its associated management controller is installed to the information platform;
an operating mode setting module, which is capable of setting the associated management controller to active mode in the event that the management controller installation status detecting module detects that no other management controller is installed on the information platform, and to standby mode in the event that another management controller has been already installed on the information platform;
a failure detecting module, which is activated in the event of the associated management controller being set to active mode to continually detect whether the associated management controller operates normally, and if not, capable of issuing a standby enable signal;
a standby activation module, which is capable of being activated in response to the standby enable signal from the failure detecting module to switch the standby management controller to active mode; and
a task handover module, which is capable of being activated in response to the standby enable signal from the failure detecting module to hand over all the current management control functions that are handled by the failed management controller to the standby management controller.

2. The redundant management control arbitration system of claim 1, wherein the information platform is a blade server.

3. The redundant management control arbitration system of claim 2, wherein each management controller of the blade server is connected to a group of interfaces including a configuration data reception interface, a SerDeS (Serializer and Deserializer) interface, a HiGiG interface, an IPMI (Intelligent Platform Management Interface) interface, an I2C (Inter Integrated Circuit) interface, an RJ45 Giga interface, an FC (Fibre Channel) interface, a UART (Universal Asynchronous Receiver/Transmitter) interface, and a Magnetic RJ45 interface.

4. The redundant management control arbitration system of claim 2, wherein the active management control module and the standby management control module are interconnected to each other by a group of redundancy-oriented interfaces including an arbitration/switching control signal bus, a 10/100 Ethernet bus, and a HiGiG bus.

5. The redundant management control arbitration system of claim 1, wherein each management controller is a BMC (Baseboard Management Controller) unit that supports the standard IPMI (Intelligent Platform Management Interface) protocol.

6. The redundant management control arbitration system of claim 1, wherein the controller installation status detecting module, the operating mode setting module, the failure detecting module, and the standby activation module are implemented as a single CPLD/ASIC (Complex Programmable Logic Device & Application Specific Integrated Circuit) chipset.

7. A redundant management control arbitration system for use with a blade server's management controller to allow the blade server to install with at least two management controllers, including an active management controller and a standby management controller as redundancy backup to the active management controller, and which allows the firstly-installed management controller to be automatically set to active mode and the secondly-installed management controller to be automatically set to standby mode, and further allows the standby management controller to be promptly switched to active mode in the event of a failure to the active management controller for the purpose of allowing the blade server to continue to operate normally in this event;
the redundant management control arbitration system comprising:
a management controller installation status detecting module, which is capable of detecting whether the blade server has been installed with another management controller after its associated management controller is installed to the blade server;
an operating mode setting module, which is capable of setting the associated management controller to active mode in the event that the management controller installation status detecting module detects that no other management controller is installed on the blade server, and to standby mode in the event that another management controller has been already installed on the blade server;
a failure detecting module, which is activated in the event of the associated management controller being set to active mode to continually detect whether the associated management controller operates normally, and if not, capable of issuing a standby enable signal;
a standby activation module, which is capable of being activated in response to the standby enable signal from the failure detecting module to switch the standby management controller to active mode; and
a task handover module, which is capable of being activated in response to the standby enable signal from the failure detecting module to hand over all the current management control functions that are handled by the failed management controller to the standby management controller.

8. The redundant management control arbitration system of claim 7, wherein each management controller of the blade server is connected to a group of interfaces including a configuration data reception interface, a SerDeS (Serializer and Deserializer) interface, a HiGiG interface, an IPMI (Intelligent Platform Management Interface) interface, an I2C (Inter Integrated Circuit) interface, an RJ45 Giga interface, an FC (Fibre Channel) interface, a UART (Universal Asynchronous Receiver/Transmitter) interface, and a Magnetic RJ45 interface.

9. The redundant management control arbitration system of claim 7, wherein the active management control module and the standby management control module are interconnected to each other by a group of redundancy-oriented interfaces including an arbitration/switching control signal bus, a 10/100 Ethernet bus, and a HiGiG bus.

10. The redundant management control arbitration system of claim 7, wherein each management controller is a BMC (Baseboard Management Controller) unit that supports the standard IPMI (Intelligent Platform Management Interface) protocol.

11. The redundant management control arbitration system of claim 7, wherein the controller installation status detecting module, the operating mode setting module, the failure detecting module, and the standby activation module are implemented as a single CPLD/ASIC (Complex Programmable Logic Device & Application Specific Integrated Circuit) chipset.
